(19) United States
(12) Patent Application Publication
(10) Pub. No.: US 2011/0181734 A1
(43) Pub. Date: Jul. 28, 2011

(54) CALIBRATION PARAMETER CREATING APPARATUS

(75) Inventors: Keisuke ASARI, Katano-shi (JP); Yohei ISHII, Osaka-shi (JP)

(73) Assignee: SANYO ELECTRIC CO., LTD., Osaka (JP)

(21) Appl. No.: 13/013,778

(22) Filed: Jan. 25, 2011

(30) Foreign Application Priority Data
Jan. 26, 2010 (JP) 2010-14237

(51) Int. Cl. H04N 17/00

(52) U.S. Cl. 348/187; 348/E17.002

(57) ABSTRACT

A calibration parameter creating apparatus includes a first reproducer. A first reproducer reproduces a reference image representing a state in which a plane is overlooked, along an X axis and a Y axis orthogonal to each other. A first acceptor accepts a first designating manipulation designating a plurality of X-Y coordinates on the reference image reproduced by the first reproducer. A determiner determines whether or not a designated manner by the first designating manipulation matches an error condition, based on the plurality of X-Y coordinates designated by the first designating manipulation. A first generator generates a notification when a determined result of the determiner is positive. A calculator calculates a calibration parameter indicating a corresponding relationship between an X-Y coordinate system and a U-V coordinate system based on the X-Y coordinates designated by the first designating manipulation, when the determined result of the determiner is negative.

### CROSS REFERENCE OF RELATED APPLICATION

The disclosure of Japanese Patent Application No. 2010-14237, which was filed on Jan. 26, 2010, is incorporated herein by reference.

### BACKGROUND OF THE INVENTION

1. Field of the Invention

The present invention relates to a calibration parameter creating apparatus. More particularly, the present invention relates to a calibration parameter creating apparatus which creates a calibration parameter indicating a corresponding relationship between two coordinate systems different from each other.

2. Description of the Related Art

When a plane which is defined along x-y axes and a plane which is defined by an x′-axis and a y′-axis are assumed, a corresponding relationship between an x-y coordinates and an x′-y′ coordinates is expressed by a transformation equation using a 3 by 3 invertible matrix. In other words, a numerical value which constructs the invertible matrix, i.e., a calibration parameter, is calculated by applying the four sets of x-y coordinates and x′-y′ coordinates mutually corresponding to the transformation equation.

However, depending on a designating manner of the coordinates, it is impossible to calculate the calibration parameter, or an error of the calibration parameter is increased. In other words, in order to calculate the calibration parameter accurately, it ought to be adequate to designate the coordinates. This makes a vendor who is not familiar with the calibration principle bear a heavy burden.

### SUMMARY OF THE INVENTION

A calibration parameter creating apparatus according to the present invention, comprises: a first reproducer which reproduces a reference image representing a state in which a plane is overlooked along an X axis and a Y axis orthogonal to each other; a first acceptor which accepts a first designating manipulation designating a plurality of X-Y coordinates on the reference image reproduced by the first reproducer; a determiner which determines whether or not a designated manner by the first designating manipulation matches an error condition, based on the plurality of X-Y coordinates designated by the first designating manipulation; a first generator which generates a notification when a determined result of the determiner is positive; and a calculator which calculates a calibration parameter indicating a corresponding relationship between an X-Y coordinate system and a U-V coordinate system based on the X-Y coordinates designated by the first designating manipulation, when the determined result of the determiner is negative.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a register applied to the embodiment in FIG. 2;

FIG. 4 is an illustrative view showing one example of an installation state of a camera applied to the embodiment in FIG. 2;

FIG. 5 is an illustrative view showing one example of a camera image displayed on a monitor of the embodiment in FIG. 2;

FIG. 6 is an illustrative view showing one example of a designation state of X-Y coordinates on a map image displayed on the monitor of the embodiment in FIG. 2;

FIG. 7 is an illustrative view showing another example of the designation state of the X-Y coordinates on the map image displayed on the monitor of the embodiment in FIG. 2;

FIG. 8 is an illustrative view showing still another example of the designation state of the X-Y coordinates on the map image displayed on the monitor of the embodiment in FIG. 2;

FIG. 9 is an illustrative view showing one example of a designation state of U-V coordinates on the camera image displayed on the monitor of the embodiment in FIG. 2;

FIG. 10 is a flowchart showing one portion of behavior of a CPU applied to the embodiment in FIG. 2;

FIG. 11 is a flowchart showing another portion of the behavior of the CPU applied to the embodiment in FIG. 2;

FIG. 12 is a flowchart showing still another portion of the behavior of the CPU applied to the embodiment in FIG. 2; and

FIG. 13 is a flowchart showing yet another portion of the behavior of the CPU applied to the embodiment in FIG. 2.

### DETAILED DESCRIPTION OF THE PREFERRED EMBODIMENTS

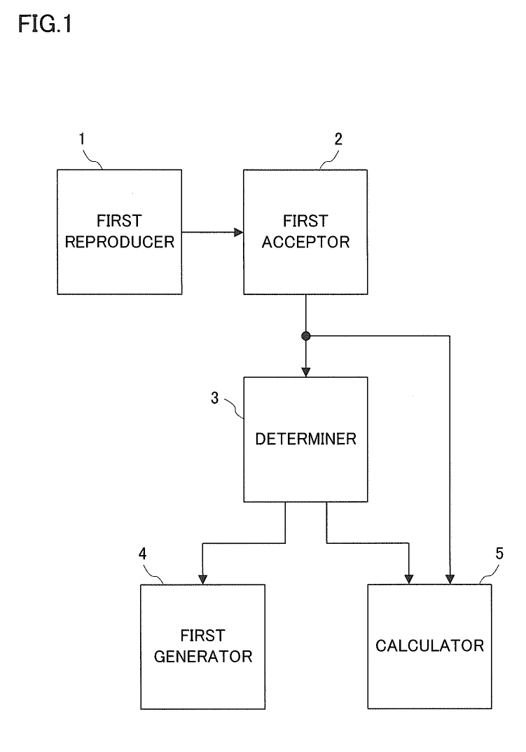

With reference to FIG. 1, a calibration parameter creating apparatus of one embodiment of the present invention is basically configured as follows: A first reproducer 1 reproduces a reference image representing a state in which a plane is overlooked, along an X axis and a Y axis orthogonal to each other. A first acceptor 2 accepts a first designating manipulation designating a plurality of X-Y coordinates on the reference image reproduced by the first reproducer 1. A determiner 3 determines whether or not a designated manner by the first designating manipulation matches an error condition, based on the plurality of X-Y coordinates designated by the first designating manipulation. A first generator 4 generates a notification when a determined result of the determiner 3 is positive. A calculator 5 calculates a calibration parameter indicating a corresponding relationship between an X-Y coordinate system and a U-V coordinate system based on the X-Y coordinates designated by the first designating manipulation, when the determined result of the determiner 3 is negative.

Thus, the plurality of X-Y coordinates is designated on the reference image representing the state in which the plane is outlined or overlooked. If a disposition of the designated X-Y coordinates matches the error condition, the notification is generated while if the disposition of the designated X-Y coordinates does not match the error condition, the calibration parameter is calculated based on the designated X-Y coordinates. Thereby, it becomes possible to reduce a burden of setting task of the calibration parameter.

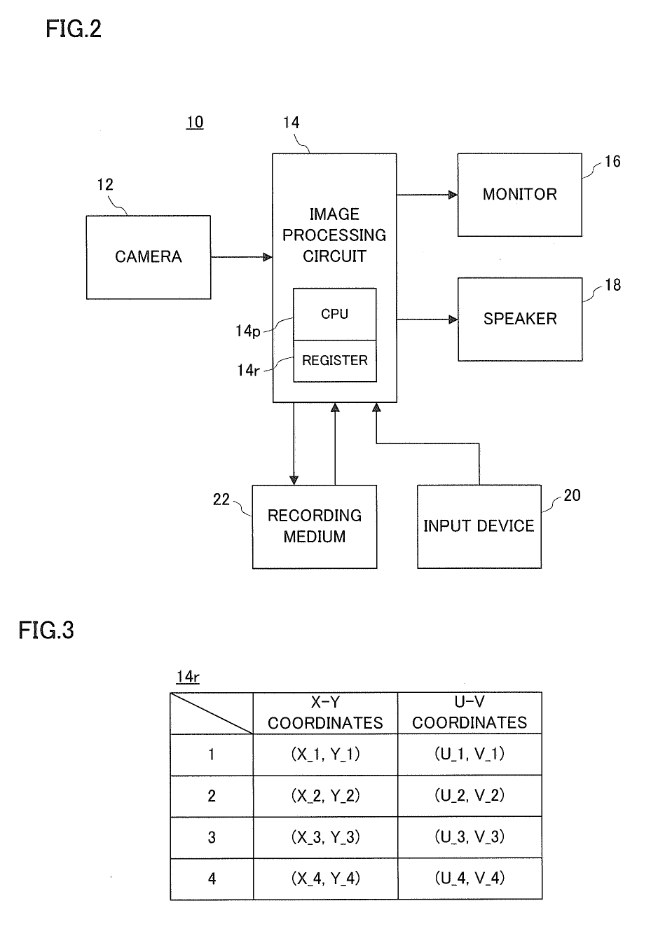

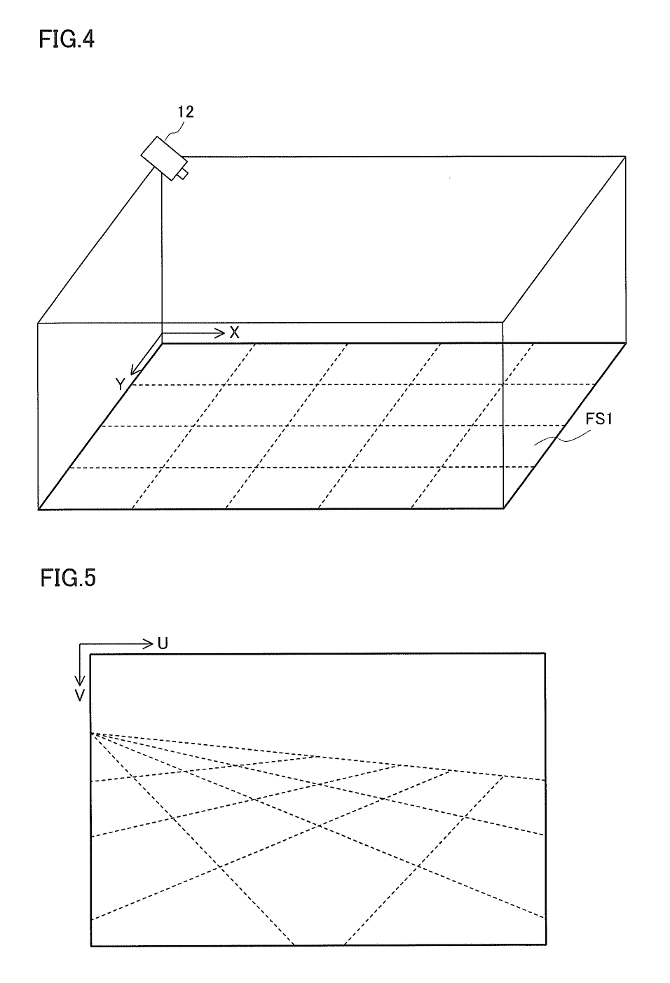

With reference to FIG. 2, a calibration parameter creating apparatus 10 according to this embodiment includes a camera 12 that repeatedly outputs image data representing a scene. The image data outputted from the camera 12 is taken by an image processing circuit 14, and subjected to a camera-image display process by a CPU 14p. As a result, an image representing the scene, i.e., a camera image, is displayed on a monitor 16. With reference to FIG. 4, the camera 12 is installed at an upper portion on a wall surface or a ceiling of a room having a plane FS1, and captures the plane FS1 from a diagonally upper position. Therefore, the camera image is displayed on a monitor screen as shown in FIG. 5. As shown in FIG. 4 and FIG. 5, the plane FS1 is defined by the X axis and the Y axis orthogonal to each other, and the camera image is reproduced along a U axis and a V axis orthogonal to each other.

When an manipulator performs a calibration parameter creating manipulation by using an input device 20 including a mouse pointer, a calibration parameter creating process described below is executed by the CPU 14p.

Firstly, a map image representing a state in which the plane FS1 is viewed from directly above is displayed on the monitor 16, and an X-Y coordinates designating manipulation of clicking desired X-Y coordinates on the map image is accepted from the manipulator through the input device 20. A variable K is updated from “1” to “4” at each X-Y coordinates designating manipulation. X-Y coordinates (X_K, Y_K) designated by a K-th X-Y coordinates designating manipulation are set to a K-th column of a register 14r shown in FIG. 3. Moreover, corresponding to the designated X-Y coordinates (X_K, Y_K), a dot DM_K is displayed on the monitor 16.

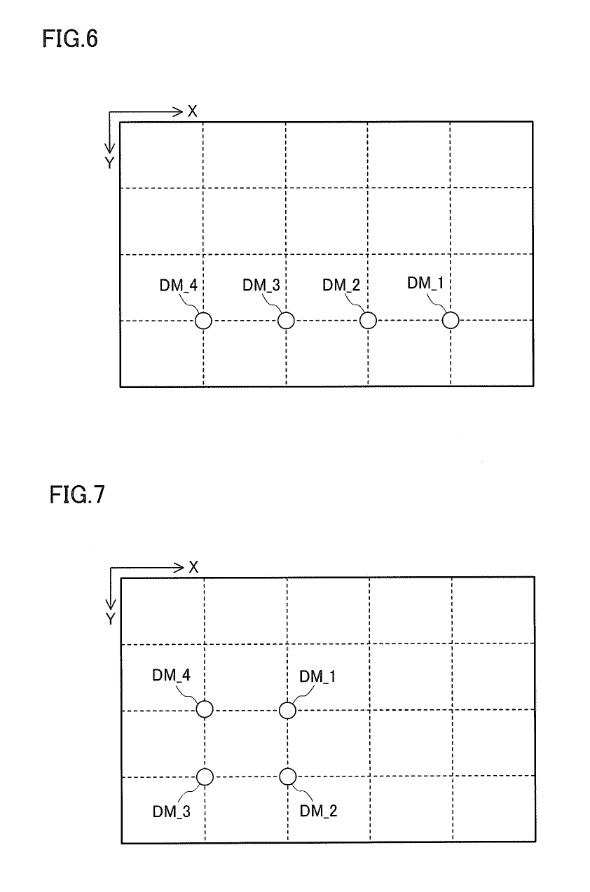

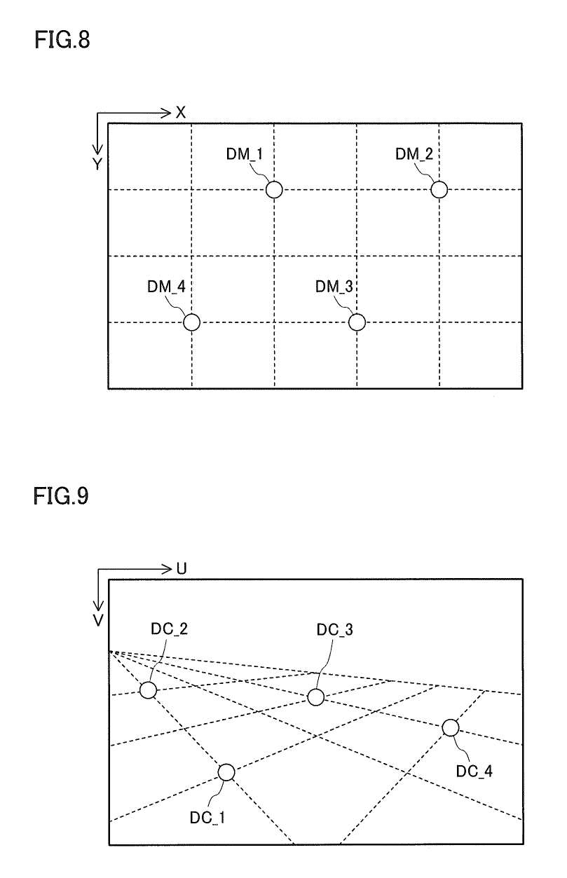

Thus, a total of four X-Y coordinates designating manipulations are accepted. The designated four X-Y coordinates (X_{—}1, Y_{—}1) to (X_{—}4, Y_{—}4) are set to the register 14r, and the corresponding dots DM_1 to DM_4 are displayed on the map image as shown in FIG. 6, FIG. 7 or FIG. 8, for example.

Upon completion of four times of the X-Y coordinates designating manipulation, based on the X-Y coordinates (X_{—}1, Y_{—}1) to (X_{—}4, Y_{—}4) set in the register 14r, it is determined whether or not the dots DM_1 to DM_4 are disposed straight on the map image. Moreover, dimensions of an area surrounded by the dots DM_1 to DM_4 are calculated based on the X-Y coordinates (X_{—}1, Y_{—}1) to (X_{—}4, Y_{—}4) set in the register 14r so as to determine whether or not the calculated dimensions fall below a reference value REF. Herein, the reference value REF is equivalent to 1/10th of the dimensions of the plane FS1, for example.

When the dots DM_1 to DM_4 are disposed straight, or when the dimensions of the area surrounded by the dots DM_1 to DM_4 fall below the reference value REF, it is regarded that the disposition of the dots DM_1 to DM_4 matches the error condition, and a notification indicating “NG” is outputted from a speaker 18. The dots DM_1 to DM_4 are non-displayed in association with a notification process, and also the register 14r is cleared in association with the notification process. Accepting the X-Y coordinates designating manipulation is restarted after the register 14r is cleared.

Thus, when the X-Y coordinates (X_{—}1, Y_{—}1) to (X_{—}4, Y_{—}4) are designated as shown in FIG. 6, the notification process is executed as the dots DM_1 to DM_4 being disposed straight on the map image. Moreover, when the X-Y coordinates (X_{—}1, Y_{—}1) to (X_{—}4, Y_{—}4) are designated as shown in FIG. 7, the notification process is executed as the dimensions of the area surrounded by the dots DM_1 to DM_4 falling below the reference value REF.

It is noted that the notification process is executed in a case where the dots DM_1 to DM_4 are disposed straight on the map image because it is impossible to express the plane with the disposition and calculate the calibration parameter described later. Moreover, the notification process is executed in a case where the dimensions of the area surrounded by the dots DM_1 to DM_4 fall below the reference value REF because an error is increased outside of the area surrounded by the dots DM_1 to DM_4 when the calibration parameter which is calculated based on the disposition is used.

When the X-Y coordinates (X_{—}1, Y_{—}1) to (X_{—}4, Y_{—}4) are designated as shown in FIG. 8, it is regarded that the disposition of the dots DM_1 to DM_4 does not match the error condition. At this time, a notification “please dispose a marker at the designated X-Y coordinates” is outputted from the speaker 18.

With reference to the map image, the manipulator disposes four markers having mutually different colors on the plane FS1, corresponding to the X-Y coordinates (X_{—}1, Y_{—}1) to (X_{—}4, Y_{—}4). Upon completion of the disposition of the markers, the manipulator performs a U-V coordinates designating manipulation of clicking positions of four markers appeared in the camera image. Depending on the color of the marker, the U-V coordinates designating manipulation is performed in an order corresponding to an order of the X-Y coordinates designating manipulation.

A variable K is updated from “1” to “4” at each U-V coordinates designating manipulation. U-V coordinates (U_K, V_K) designated by a K-th U-V coordinates designating manipulation are set to a K-th column of the register 14r. Moreover, corresponding to the designated U-V coordinates (U_K, V_K), a dot DC_K is displayed on the camera image.

Thus, also a total of four U-V coordinates designating manipulations are accepted. The designated four U-V coordinates (U_{—}1, V_{—}1) to (U_{—}4, V_{—}4) are set to the register 14r, and the corresponding dots DC_1 to DC_4 are displayed on the camera image as shown in FIG. 9, for example.

When the X-Y coordinates (X_{—}1, Y_{—}1) to (X_{—}4, Y_{—}4) and the U-V coordinates (U_{—}1, V_{—}1) to (U_{—}4, V_4) are thus set to the register 14r, calibration parameters P 11 to P33 representing the corresponding relationship between the X-Y coordinate system and the U-V coordinate system are calculated based on a planar projective transformation matrix equation shown in Equation 1.

$$[ \begin{matrix}U \\ V \\ 1\end{matrix} ] = [ \begin{matrix}P 11 & P 12 & P 13 \\ P 21 & P 22 & P 23 \\ P 31 & P 32 & P 33\end{matrix} ] [ \begin{matrix}X \\ Y \\ 1\end{matrix} ] \qquad [ Equation 1 ]$$

More specifically, the mutually corresponding X-Y coordinates (X_K, Y_K) and U-V coordinates (U_K, V_K) are applied to Equation 1, and thereby, eight transformation equations (four equations for the U coordinate and four equations for the V coordinate) are produced. The calibration parameters P11 to P33 are calculated by solving simultaneous equations derived from the produced eight transformation equations.

Thus, when the setting of the dots DM_1 to DM_4 matches the error condition, the notification is generated so as to request to perform again the X-Y coordinates designating manipulation. A calculation process for the calibration parameters P11 to P33 is executed when the dots DM_1 to DM_4 are set in a manner which does not match the error condition. Thereby, it becomes possible for a vendor who is not familiar with the calibration principle to reduce the burden of performing the setting task of the calibration parameters P11 to P33 (specifically, the burden of disposing the four markers on the plane).

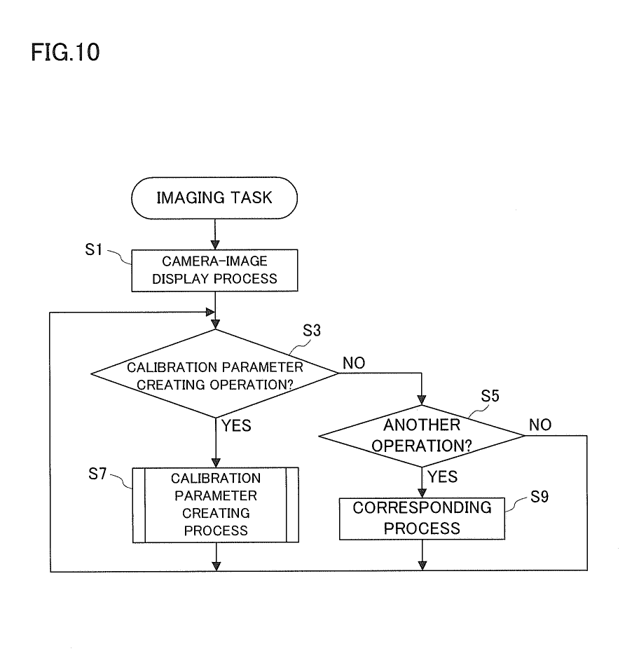

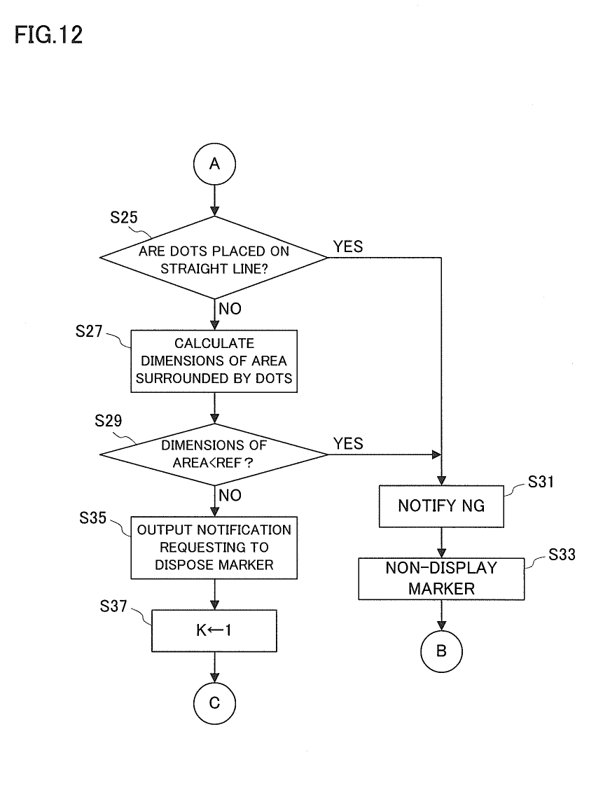

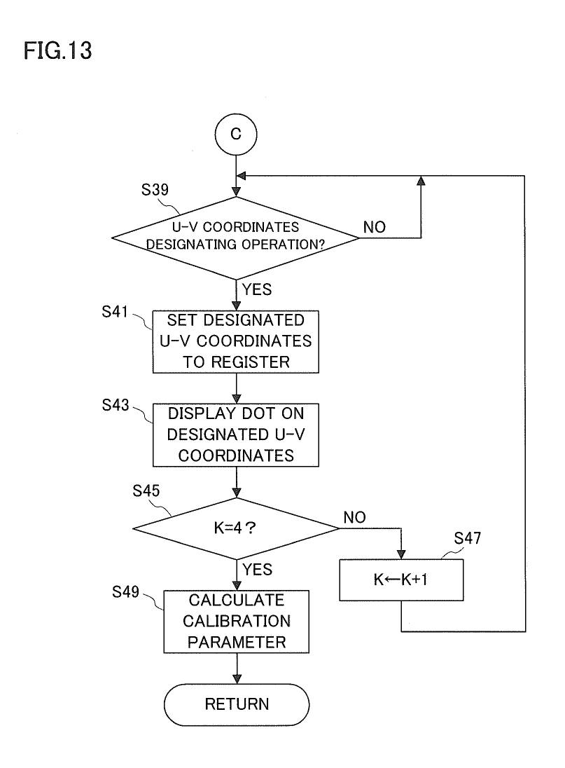

The CPU 14p executes processes according to an imaging task shown in FIG. 10 to FIG. 13. It is noted that control programs corresponding to these tasks are stored in a recording medium 22.

With reference to FIG. 10, in a step S1, the camera-image display process is executed. As a result, the camera image is displayed on the monitor 16. In a step S3, it is determined whether or not the calibration parameter creating manipulation is performed, and in a step S5, it is determined whether or not another manipulation is performed. When YES is determined in the step S3, the calibration parameter creating process is executed in a step S7, and thereafter, the process returns to the step S3. When YES is determined in the step S5, a corresponding process is executed in a step S9, and thereafter, the process returns to the step S3. When NO is determined in both the steps S3 and S5, the process directly returns to the step S3.

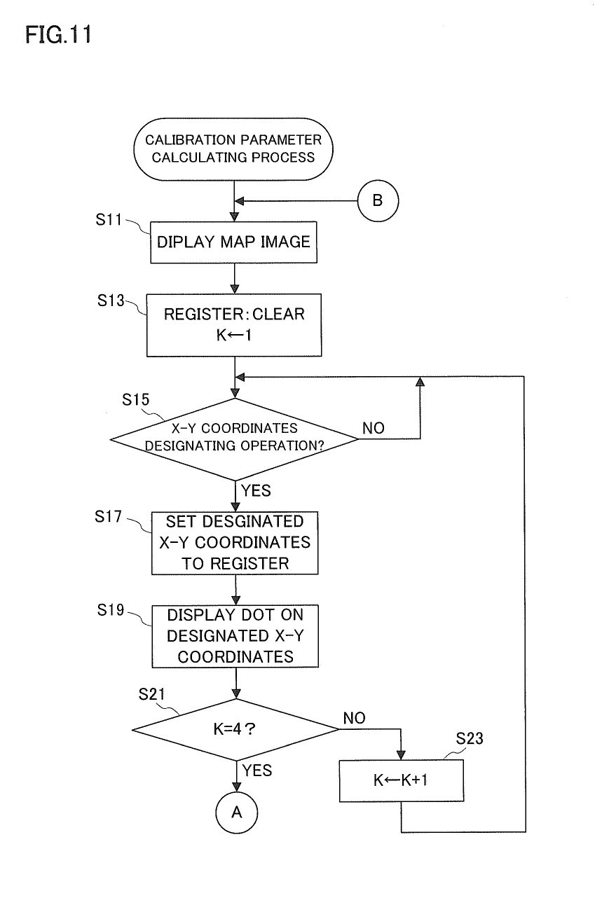

The calibration parameter creating process in the step S7 is executed according to a subroutine shown in FIG. 11 to FIG. 13. Firstly, in a step S11, the map image representing the state in which the plane FS1 is viewed from directly above is displayed on the monitor 16. In a step S13, the register 14r is cleared, and the variable K is set to “1”. In a step S15, it is repeatedly determined whether or not the X-Y coordinates designating manipulation is performed. When a determined result is updated from NO to YES, the process advances to a step S17 so as to set the X-Y coordinates (X_K, Y_K) designated by the X-Y coordinates designating manipulation to the K-th column of the register 14r. In a step S19, corresponding to the designated X-Y coordinates (X_K, Y_K), the dot DM_K is displayed on the map image.

In a step S21, it is determined whether or not the variable K reaches “4”, and when a determined result is NO, the process returns to the step S15 after incrementing the variable K in a step S23 while when the determined result is YES, the process advances to a step S25.

In the step S25, based on the X-Y coordinates (X_{—}1, Y_{—}1) to (X_{—}4, Y_{—}4) set in the register 14r, it is determined whether or not the dots DM_1 to DM_4 are disposed straight on the map image. Moreover, in a step S27, the dimensions of the area surrounded by the dots DM_1 to DM_4 are calculated based on the X-Y coordinates (X_{—}1, Y_{—}1) to (X_{—}4, Y_{—}4) set in the register 14r, and in a step S29, it is determined whether or not the calculated dimensions fall below the reference value REF.

When YES is determined in any one of the steps S25 and S29, it is regarded that the disposition of the dots DM_1 to DM_4 matches the error condition, and in a step S31, a notification sound indicating “NG” is outputted from the speaker 18. In a step S33, the dots DM_1 to DM_4 are non-displayed, and thereafter, the process returns to the step S11.

When NO is determined in both the steps S25 and S29, it is regarded that the disposition of the dots DM_1 to DM_4 does not match the error condition, and in a step S35, the notification “please dispose the marker at the designated X-Y coordinates” is outputted from the speaker 18. With reference to the map image, the manipulator disposes the four markers on the plane FS1, corresponding to the X-Y coordinates (X_{—}1, Y_{—}1) to (X_{—}4, Y_{—}4).

In a step S37, the variable K is set to “1”, and it is repeatedly determined in a step S39 whether or not the U-V coordinates designating manipulation is performed by the manipulator. When a determined result is updated from NO to YES, the process advances to a step S41 so as to set the U-V coordinates (U_K, V_K) designated by the U-V coordinates designating manipulation to the K-th column of the register 14r. In a step S43, corresponding to the designated U-V coordinates (U_K, V_K), the dot DC_K is displayed on the camera image, and in a step S45, it is determined whether or not the variable K reaches “4”. When a determined result is NO, the variable K is incremented in a step S47, and then, the process returns to the step S39 while the determined result is YES, the process advances to a step S49.

In the step S49, the four X-Y coordinates and the four U-V coordinates set to the register 14r are applied to the above-described Equation 1 so as to calculate the calibration parameters P11 to P33. Upon completion of the process in the step S49, the process returns to the routine in an upper hierarchy.

As can be seen from the above-described explanation, the CPU 14p displays on the monitor 16 the map image representing the state in which the plane FS1 is outlined or overlooked along the X axis and the Y axis orthogonal to each other (S11), and accepts the X-Y coordinates designating manipulation of designating the X-Y coordinates (X_{—}1, Y_{—}1) to (X_{—}4, Y_{—}4) on the displayed map image (S15). Moreover, based on the designated X-Y coordinates (X_{—}1, Y_{—}1) to (X_{—}4, Y_{—}4), the CPU 14p determines whether or not the designated manner by the X-Y coordinates designating manipulation matches the error condition (S25, S29). When a determined result is positive, the notification is generated (S31) while when the determined result is negative, the calibration parameters P11 to P33 are calculated based on the designated X-Y coordinates (X_{—}1, Y_{—}1) to (X_{—}4, Y_{—}4) (S35 to S49).

Thus, the X-Y coordinates (X_{—}1, Y_{—}1) to (X_{—}4, Y_{—}4) are designated on the map image representing the state in which the plane is outlined or overlooked. When the disposition of the X-Y coordinates (X_{—}1, Y_{—}1) to (X_{—}4, Y_{—}4) matches the error condition, the notification is generated while when the disposition of the X-Y coordinates (X_{—}1, Y_{—}1) to (X_{—}4, Y_{—}4) does not match the error condition, the calibration parameters P11 to P33 are calculated based on the X-Y coordinates (X_{—}1, Y_{—}1) to (X_{—}4, Y_{—}4). Thereby, it becomes possible to reduce the burden of setting task of the calibration parameters P11 to P33.

It is noted that, in this embodiment, the plane FS1 is captured from the diagonally upper position by the camera 12 installed at the upper portion on the wall surface, however, instead thereof, the plane FS1 may be captured from directly above by an omnidirectional camera set on the ceiling.

Furthermore, in this embodiment, the calibration parameter is calculated based on the four U-V coordinates and the four X-Y coordinates, however, the number of coordinates to be referred to in order to calculate the calibration parameter may be “5” or more.

Moreover, in this embodiment, the U-V coordinates are designated by clicking the mouse pointer. However, instead thereof, a numerical value indicating the U-V coordinates may be input, and furthermore, the U-V coordinates may be specified by recognizing the marker disposed on the plane FS1.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A calibration parameter creating apparatus, comprising:
a first reproducer which reproduces a reference image representing a state in which a plane is overlooked along an X axis and a Y axis orthogonal to each other;
a first acceptor which accepts a first designating manipulation designating a plurality of X-Y coordinates on the reference image reproduced by said first reproducer;
a determiner which determines whether or not a designated manner by the first designating manipulation matches an en error condition, based on the plurality of X-Y coordinates designated by the first designating manipulation;
a first generator which generates a notification when a determined result of said determiner is positive; and
a calculator which calculates a calibration parameter indicating a corresponding relationship between an X-Y coordinate system and a U-V coordinate system based on the X-Y coordinates designated by the first designating manipulation, when the determined result of said determiner is negative.

2. A calibration parameter creating apparatus according to claim 1, further comprising a second reproducer which reproduces a scene image outputted from a camera that captures the plane, along a U axis and a V axis orthogonal to each other, wherein said calculator includes a second acceptor which accepts a second designating manipulation of designating a plurality of U-V coordinates on the scene image reproduced by said second reproducer and a calculation processor which calculates the calibration parameter indicating the corresponding relationship between the X-Y coordinate system and the U-V coordinate system based on the plurality of X-Y coordinates designated by said first designating manipulation and the plurality of U-V coordinates designated by said second designating manipulation.

3. A calibration parameter creating apparatus according to claim 2, further comprising a second generator which generates a notification requesting to dispose a plurality of markers providing an indication of said second designating manipulation in association with an accepting process of said second acceptor.

4. A calibration parameter creating apparatus according to claim 1, wherein the error condition includes a first condition under which the plurality of X-Y coordinates designated by said first designating manipulation exist on a straight line.

5. A calibration parameter creating apparatus according to claim 1, wherein the error condition includes a second condition under which dimensions of an area surrounded by the plurality of X-Y coordinates designated by said first designating manipulation fall below a reference.

6. A calibration parameter creating apparatus according to claim 1, further comprising a restarter which restarts said first acceptor in association with a generating process of said first generator.
